(19) United States
(12) Patent Application Publication
(10) Pub. No.: US 2014/0229608 A1
(43) Pub. Date: Aug. 14, 2014

(54) PARSIMONIOUS MONITORING OF SERVICE LATENCY CHARACTERISTICS

(71) Applicants: Eric Bauer, Freehold (NJ); Roger Maitland, Woodlawn (CA); Iraj Saniee, New Providence, NJ (US)

(72) Inventors: Eric Bauer, Freehold (NJ); Roger Maitland, Woodlawn (CA); Iraj Saniee, New Providence, NJ (US)

(73) Assignees: Alcatel-Lucent Canada Inc., Ottawa (CA); Alcatel-Lucent USA Inc., Murray Hill, NJ (US)

(21) Appl. No.: 13/767,464

(22) Filed: Feb. 14, 2013

(51) Int. Cl. H04L 12/26

(52) U.S. Cl. CPC H04L 43/00
USPC 709/224

(57) ABSTRACT

Various exemplary embodiments relate to a method of evaluating cloud network performance. The method includes: measuring a latency of a plurality of service requests in a cloud-network; determining a mean latency; and determining a variance of the plurality of service requests; comparing the mean latency to a first threshold; comparing the variance to a second threshold; and determining that the cloud-network is deficient if either the mean latency exceeds the first threshold or the variance exceeds the second threshold.

### TECHNICAL FIELD

Various exemplary embodiments disclosed herein relate generally to cloud computing.

### BACKGROUND

Cloud computing allows a cloud service provider to provide computing resources to a cloud customer through the use of virtualized machines. Cloud computing allows optimized use of computing resources by sharing resources and booting resource utilization, which may reduce computing costs for application providers. Cloud computing allows rapid expansion of computing capability by allowing a cloud consumer to add additional virtual machines on demand. Given the benefits of cloud computing, various computing solutions traditionally implemented as non-virtualized servers are being moved to the cloud. Traditional metrics for measuring performance of computing solutions may not be as useful for measuring performance of cloud solutions. Additionally, because virtualization deliberately hides resource sharing, it may also hide true performance measurements from applications.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of evaluating cloud network performance. The method includes: determining a latency of a plurality of service requests in a cloud-network; determining a mean latency; determining a variance of the plurality of service requests; comparing the mean latency to a first threshold; comparing the variance to a second threshold; and determining that the cloud-network is deficient based on the mean latency exceeding the first threshold or the variance exceeding the second threshold.

In various embodiments, the first threshold and the second threshold are defined by a service level agreement between a cloud consumer and a cloud provider.

In various embodiments, the method further includes sending a request to a cloud service provider for a service credit.

In various embodiments, the method further includes improving performance for an application in the cloud-network based on the detected deficiency. Improving performance may include allocating additional virtual resource capacity. Improving performance may include migrating a virtual machine to a different host. Improving performance may include terminating a poorly performing virtual machine instance.

In various embodiments, the method further includes storing the mean latency and variance for a measurement window.

In various embodiments the latency is one of application service latency, scheduling latency, disk input/output latency, network latency, clock event jitter latency, and virtual machine allocation latency.

In various embodiments, the step of measuring is performed by an application hosted on a virtual machine of the cloud-network. In various embodiments, the step of measuring is performed by a guest operating system of a virtual machine being executed by a processor of the cloud-network.

Various embodiments relate to the above described methods encoded on a non-transitory machine-readable storage medium as instructions executable by a processor.

Various embodiments relate to an apparatus including a data storage communicatively connected to a processor configured to perform the above method.

It should be apparent that, in this manner, various exemplary embodiments enable measurement of cloud network performance. In particular, by measuring mean latency and variance, a cloud consumer may obtain useful metrics of cloud network performance while minimizing network resources required to obtain and store such metrics.

### BRIEF DESCRIPTION OF THE DRAWINGS

In order to better understand various exemplary embodiments, reference is made to the accompanying drawings, wherein:

FIG. 1 illustrates a cloud network for providing cloud-based applications;

FIG. 2 illustrates a cumulative complimentary distribution function showing benchmark service latency on three infrastructures; and

FIG. 3 illustrates a flowchart showing a method of detecting service level agreement breaches.

FIG. 4 schematically illustrates an embodiment of various apparatus of cloud network such as resources at data centers.

### DETAILED DESCRIPTION

Referring now to the drawings, in which like numerals refer to like components or steps, there are disclosed broad aspects of various exemplary embodiments.

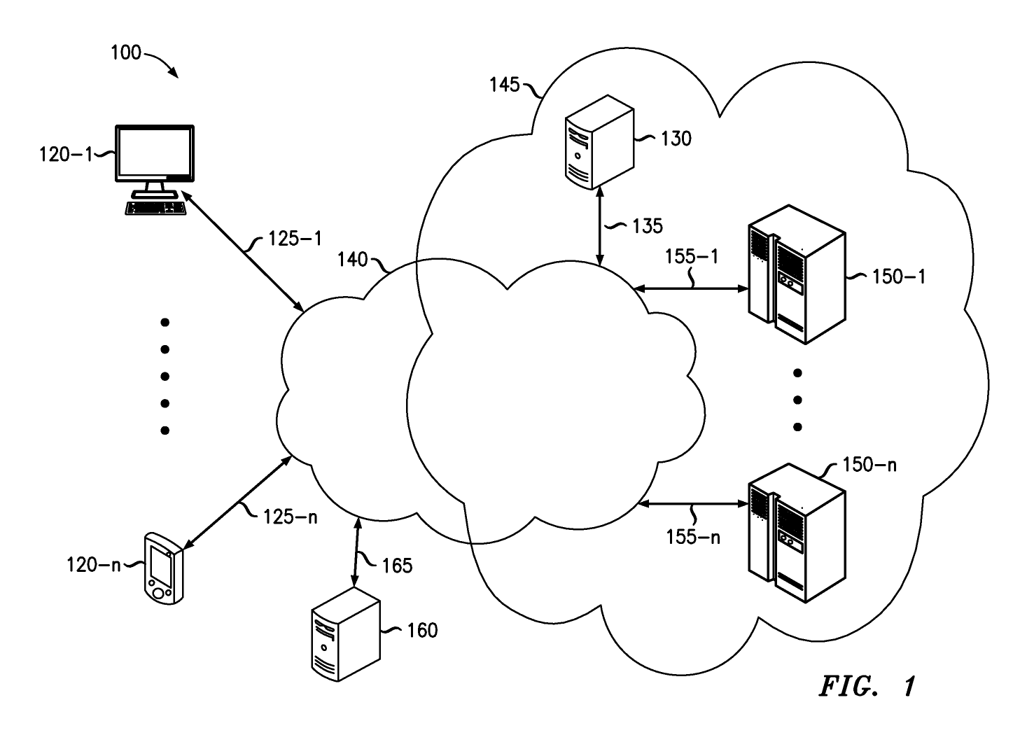

FIG. 1 illustrates a cloud network 100 for providing cloud-based applications. The cloud network 100 includes one or more clients 120-1-120-n (collectively, clients 120) accessing one or more application instances (not shown for clarity) residing on one or more of data centers 150-1-150-n (collectively, data centers 150) over a communication path. The communication path includes an appropriate one of client communication channels 125-1-125-n (collectively, client communication channels 125), network 140, and one of data center communication channels 155-1-155-n (collectively, data center communication channels 155). The application instances are allocated in one or more of data centers 150 by a cloud manager 130 communicating with the data centers 150 via a cloud manager communication channel 135, the network 140 and an appropriate one of data center communication channels 155. The application instances may be controlled by an application provider 160, who has contracted with cloud service network 145.

Clients 120 may include any type of communication device(s) capable of sending or receiving information over network 140 via one or more of client communication channels 125. For example, a communication device may be a thin client, a smart phone (e.g., client 120-n), a personal or laptop computer (e.g., client 120-1), server, network device, tablet, television set-top box, media player or the like. Communication devices may rely on other resources within exemplary system to perform a portion of tasks, such as processing or storage, or may be capable of independently performing tasks. It should be appreciated that while two clients are illustrated here, system 100 may include fewer or more clients. Moreover, the number of clients at any one time may be dynamic as clients may be added or subtracted from the system at various times during operation.

The communication channels 125, 135 and 155 support communicating over one or more communication channels such as: wireless communications (e.g., LTE, GSM, CDMA); WLAN communications (e.g., WiFi); packet network communications (e.g., IP); broadband communications (e.g., DOCSIS and DSL); storage communications (e.g., Fibre Channel, iSCSI) and the like. It should be appreciated that though depicted as a single connection, communication channels 125, 135 and 155 may be any number or combinations of communication channels.

Cloud manager 130 may be any apparatus that allocates and de-allocates the resources in data centers 150 to one or more application instances. In particular, a portion of the resources in data centers 150 are pooled and allocated to the application instances via component instances. It should be appreciated that while only one cloud manager is illustrated here, system 100 may include more cloud managers. In some embodiments, cloud manager 130 may be a hierarchical arrangement of cloud managers.

The term “component instance” as used herein means one or more allocated resources reserved to service requests from a particular client application. For example, an allocated resource may be processing/compute, memory, networking, storage or the like. In some embodiments, a component instance may be a virtual machine comprising processing/compute, memory and networking resources. In some embodiments, a component instance may be virtualized storage. A cloud service provider may allocate virtual resources to cloud consumers and hide any virtual to physical mapping of resources from the cloud consumer.

The network 140 may include any number of access and edge nodes and network devices and any number and configuration of links. Moreover, it should be appreciated that network 140 may include any combination and any number of wireless, or wire line networks including: LTE, GSM, CDMA, Local Area Network(s) (LAN), Wireless Local Area Network(s) (WLAN), Wide Area Network (WAN), Metropolitan Area Network (MAN), or the like.

The network 145 represents a cloud provider network. The cloud provider network 145 may include the cloud manager 130, cloud manager communication channel 135, data centers 150, and data center communication channels 155. A cloud provider network 145 may host applications of a cloud consumer for access by clients 120 or other applications.

The data centers 150 may be geographically distributed and may include any types or configuration of resources. Resources may be any suitable device utilized by an application instance to service application requests from clients 120. For example, resources may be: servers, processor cores, memory devices, storage devices, networking devices or the like.

Applications manager 160 may represent an entity such as a cloud consumer who has contracted with cloud service provider such as cloud services network 145 to host application instances for the cloud consumer. Applications manager 160 may provide various modules of application software to be executed by virtual machines provided by resources at data centers 150. For example, applications manager 160 may provide a website that is hosted by cloud services network 145. In this example, data centers 150 may generate one or more virtual machines that appear to clients 120 as one or more servers hosting the website. As another example, applications manager 160 may be a telecommunications service provider that provides a plurality of different network applications for managing subscriber services. The different network applications may each interact with clients 120 as well as other applications hosted by cloud services network 145.

The contract between the cloud consumer and cloud service provider may include a service level agreement (SLA) requiring cloud services network 145 to provide certain levels of service. The SLA may define various service quality thresholds that the cloud services network 145 agrees to provide. The SLA may apply to performance of computing components or performance of networking components. If the cloud services network 145 does not meet the service quality thresholds, a cloud consumer such as the cloud consumer represented by applications manager 160 may be entitled to receive a service credit or monetary compensation.

Monitoring cloud-network performance for compliance with a SLA poses several challenges. The entity with the most direct knowledge of cloud-network performance may be the cloud-network provider. A cloud-network provider, however, may be disincentivized to aggressively monitor and report SLA breaches. A cloud-network provider may view performance measurements as proprietary business information that the provider does not want exposed to current and potential customers and potential competitors. Monitoring cloud-network performance may consume cloud-network resources such as processing and storage, which are then unavailable for serving cloud consumer needs. Additionally, a cloud network provider reporting its breach of the SLA may result in penalties to the cloud-network provider. Further, cloud-network hardware may not provide standardized measurements. A cloud-network 140, 145 may include resources and management hardware such as load balancers and hypervisors of various design from various manufacturers. Measurements provided by cloud-network hardware may not correspond to contractual terms of the SLA.

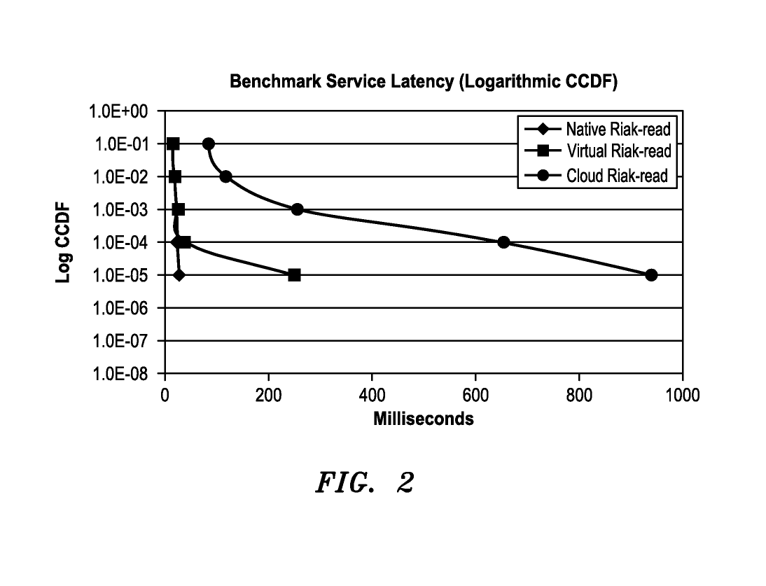

FIG. 2 illustrates a complementary cumulative distribution function (CCDF) showing benchmark service latency on three infrastructures. The CCDF has a logarithmic Y-Axis indicating the number of requests. The CCDF was built from predefined latency measurement buckets. Each point is the midpoint of the applicable measurement bucket. A standard measurement bucket technique consumes storage for each bucket. Additionally, developing a useful CCDF for a particular data set requires selecting appropriate bucket sizes before the data is measured. Too few buckets and information is lost; too many buckets and resources are squandered.

As illustrated in FIG. 2, the line for native infrastructure indicates relatively constant performance for all requests. The line for virtualized infrastructure indicates that most requests are processed with similar latency to native infrastructure, but approximately 1 in 10,000 requests suffer from much greater latency. Cloud-network performance may have different characteristics than traditional native hardware systems. For example, a cloud-network architecture may have an inherently greater latency for all service requests. This greater latency may be due to, for example, network communication latency. The performance of the cloud-network architecture may also have greater latency for a larger number of cases. As seen in FIG. 2, all requests for the cloud infrastructure have a latency of approximately 100 ms. Moreover, approximately 1 in 1000 requests has latency greater than 200 ms and some requests have even greater latency. Although end users may experience such extended latency only occasionally, such extended latency may negatively affect the end-user's experience when it does occur. For example, if cloud infrastructure is used to host an interactive video game, such extended latency or “lag spikes” may result in an unenjoyable gaming experience.

Performance metrics traditionally used for native infrastructure may not adequately characterize the problem illustrated in FIG. 2. For example, a performance metric for a particular percentile of requests, for example the 95th percentile or 99th percentile, may be suitable for native infrastructure, but not cloud infrastructure. With native infrastructure, latency may follow a well-defined distribution. With cloud infrastructure, on the other hand, outliers having extreme latency may represent serious performance problems. A percentile based metric may completely exclude the extended latencies experienced by a small number of end-users. A performance metric measuring mean latency and variance may provide a better representation of end-user experience. Moreover, mean latency and variance may be computationally easier to determine and consume fewer network resources including processing and storage.

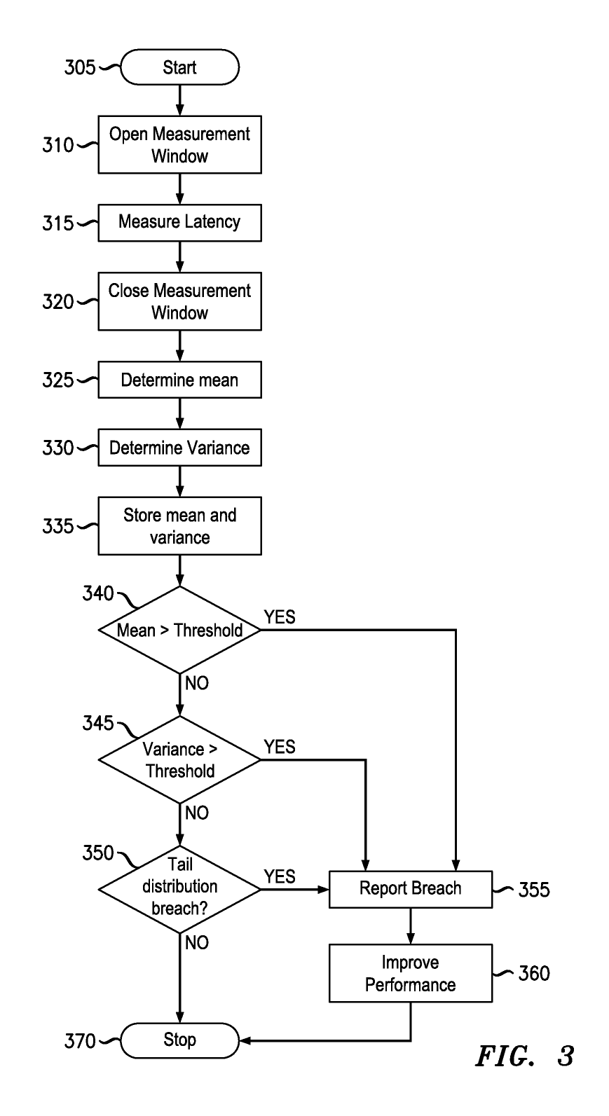

FIG. 3 illustrates a flowchart showing a method 300 of detecting service level agreement breaches. The method 300 may be performed by one or more processors located in a cloud network such as network 100. For example, method 300 may be performed by cloud resources using a module within a cloud application or a guest operating system. Method 300 may also be performed by a client device 120 or an applications manager 160. The method 300 may begin at step 305 and proceed to step 310.

In step 310, the device performing method 300 may open a measurement window. The measurement window may be a predefined interval for measuring latency. For example, a measurement window may be defined as 1, 5, 10, or 15 minutes. The length of the measurement window may be based on the type of latency being measured. In various embodiments, latency may be measured for a series of consecutive measurement windows. In various embodiments, the latency may be measured periodically or randomly. In various alternative embodiments, the measurement window may be a predefined number of latency measurements. Once a measurement window is open, the method 300 may proceed to step 315.

In step 315, the device may take one or more latency measurements. Minimally invasive measurement techniques may be used to obtain latency measurements without placing significant additional load on the system.

Various types of latency may be measured at different locations within the cloud network. For example, service latency for end-user requests may be measured by either the end-user device or the cloud resources. An end user device may measure the latency between sending a request packet and receiving a response packet. This latency measurement may include network latency as well as latency in processing the request. The application or guest operating system may use cloud resources to measure service latency between receiving the request packet and transmitting the response packet. An application or guest operating system may also measure a transaction latency or subroutine latency. Applications may also measure latency for key infrastructure accesses such as scheduling latency, disk input/output latency, and network latency.

Another type of latency that may be measured is clock event jitter. Real time applications may use clock event interrupts to regularly service isochronous traffic like streaming interactive media for video conferencing applications. The application may measure the clock event jitter latency as the time between when the interrupt was requested to occur and when the service routine is actually executed. Clock event jitter latency may use a more precise measurement such as microseconds.

Another type of latency that may be measured is VM allocation and startup latency. An application that explicitly initiates VM instance allocation may measure the time it takes for the new VM instance to become active. VM instance allocation and startup may occur on a relatively longer time scale. For example, VM allocation may occur only once in a standard measurement window and may not be completed within the measurement window. Accordingly, longer measurement windows may be used for measuring VM allocation and startup latency.

Another type of latency that may be measured is degraded capacity latency. Degraded capacity latency may be measured using well characterized blocks of code such as, for example, a routine that runs repeatedly with a consistent execution time. The application may measure actual execution time of the block of code and compare the actual execution time with an expected execution time based on past performance.

In step 320, the measuring device may close the measurement window when it determines that the measurement window has been completed. The measuring device may store raw measurement data in an appropriate data structure such as an array for further processing. In various embodiments, the measuring device may accumulate the latency values and a count of measurements as the measurements are collected. The measuring device may maintain a first sum counter (S1) that accumulates the measured latencies, a second sum counter (S2) that accumulates the squared latencies, and a third counter (S0) that increments the number of measurements. In various embodiments, the measuring device may send the raw measurement data to a centralized collection device for further processing.

In step 325, the measuring device may determine a mean latency of the collected measurements. The mean latency may be calculated by accumulating the individual measurements and dividing the cumulative total by the number of measurements. In embodiments where counters are used, the first counter (S1) may be divided by the third counter (S0) to determine the mean latency. The current mean latency may also be computed on the fly during the measurement window.

In step 330, the measuring device may determine the variance of the collected measurements. Variance may be calculated by dividing the value of the second counter S2 by the third counter S0 and subtracting from this the ratio of the square of the first counter S1 and the square of the third counter S0.

In step 335, the measuring device may store the measured mean and variance for the measurement window. An appropriate data structure such as an array may be used to store the mean and variance along with an identifier for the measurement window. After the mean and variance are determined for a measurement window, a measurement device may discard the collected measurements and store only the mean and variance. Storing only the mean and variance may consume significantly less memory resources than storing the raw measurement data, which may include thousands or millions of measurements. The mean and variance may be stored for a predefined evaluation period such as, for example, a day, week, month, or year. Alternatively, the measuring device may also store the counters for a measurement window. The counters for a measurement window may also consume significantly less memory resources than the raw measurement data. In various embodiments, the counters for one or more measurement windows may be combined to provide a larger sample size and improve estimation of the mean and variance.

In step 340, the measuring device may compare the mean latency to a threshold latency value. The threshold latency value may be defined by a SLA between the cloud provider and the cloud customer. If the mean latency exceeds the threshold latency value, the method 300 may proceed to step 355. If the mean latency is less than or equal to the threshold latency value, the method 300 may proceed to step 345.

In step 345, the measuring device may compare the variance to a threshold variance value. The threshold variance value may be defined by the SLA between the cloud provider and the cloud customer. If the variance exceeds the threshold variance value, the method 300 may proceed to step 355. If the variance is less than or equal to the threshold variance value, the method 300 may proceed to step 370, where the method 300 ends.

In step 350, the measuring device may estimate a tail latency distribution. In various embodiments, the measuring device may check for excessive tail latencies using formulae for tail probabilities. For example, Chebychev's inequality, which in this case, states that no more than 1/k² of a distribution's values are more than k standard deviations away from the mean. Accordingly, Chebychev's inequality may be used to estimate the distributions of latencies at the tail of the distribution based on the measured mean and variance. For example, if an SLA establishes a requirement of a maximum latency for a particular percentile of the requests, Chebychev's inequality may be used to determine a maximum standard deviation allowed that is sufficient to show that the requirement is met. In particular, the maximum standard deviation (σ) may be equal to the difference between the maximum latency (Xₘₐₓ) and the mean ( x̅) divided by the tail percentile (k) squared. The following formula may be used:

$$σ \leq \frac{( {X}_{Max} - \overline{x} )}{{k}^{2}} \qquad Formula 1$$

The measuring device may calculate the standard deviation of the measurement window based on the variance using the counters S0, S1, and S2. Thus, Chebychev's inequality may be used to establish and evaluate a sufficient condition for determining that the requirement of the SLA has been met. If the sufficient condition is met, no tail distribution breach has occurred.

In various embodiments, the tail distribution may be further estimated based on a known distribution type. Necessary conditions for meeting a requirement may be established based on the known distribution type and the particular requirement. Accordingly, tail distribution breaches may be detected according to the measured mean and variance and a known distribution.

If a tail percentile breach has been detected, the method 300 may proceed to step 355. If no tail percentile breach has been detected, the method may proceed to step 370 where the method 300 ends.

In various embodiments, steps 340, 345, and 350 may be performed periodically at the end of an evaluation period. For example, the measuring device, or another device such as application manager 160, may evaluate stored mean and variance values to determine whether the cloud-network has met a SLA. The stored mean and variance values for multiple measurement windows may be combined by adding the stored counters. A longer evaluation period may provide a larger sample size and a better estimation of performance.

In step 355, the measuring device may report a breach of the SLA to a cloud provider, cloud consumer, or application manager. The measuring device may report the breach in a form required by the SLA for obtaining a service credit or other compensation for the breach. The measuring device may include the mean latency and the variance when reporting the breach. A cloud customer or application manager may document the breach and use the collected information for further processing. The method 300 may proceed to step 350.

In step 360, the end-user, cloud consumer or application manager may attempt to improve performance of the cloud network.

An end-user or end-user device may attempt to connect to a different virtual machine. For example, the end-user device may select a different IP address from DNS results or manually configure a different static IP address if the virtual machine associated with an IP address provides poor performance. An end-user or end-user device may also attempt to shape traffic or shift workload. For example, an end-user device performing a periodic routine may shift the routine to a time when the cloud network provides better performance.

A cloud consumer may allocate additional virtual resource capacity and shift workload to that new capacity to improve resource performance. The cloud consumer may request the cloud provider to increase the number of virtual machines or component instances serving an application. A cloud consumer may also migrate a VM to a different host. For example, if the cloud consumer detects excessive latency related to a particular VM, migrating the VM to a different host may reduce latency caused by physical defects of the underlying component instance. Similarly, the cloud consumer may terminate a poorly performing VM instance. The workload of the VM instance may then be divided among the remaining VM instances or shifted to a newly allocated VM instance based on cloud provider procedures. In either case, terminating a poorly performing VM may remedy application performance problems due to the underlying physical resources or particular VM configuration. In addition to the improvements listed above, certain timing constraints may be relaxed with the potential side effect of adding latency to the provided service. For example, if the jitter of the cloud is beyond the SLA, settings on a downstream node, such as a packet receive window, may be adjusted to avoid packet discard.

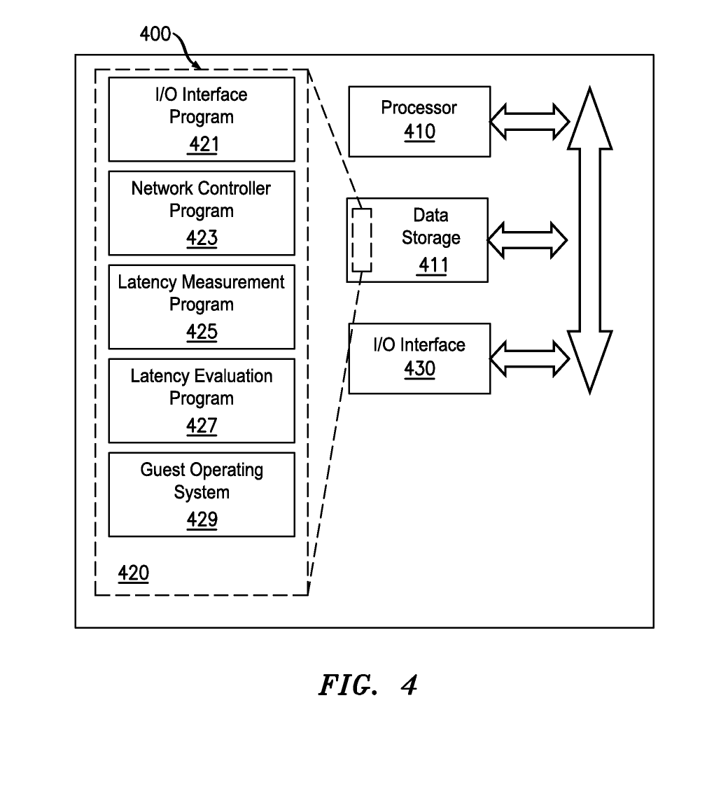

FIG. 4 schematically illustrates an embodiment of various apparatus 400 of cloud network 100 such as resources at data centers 150. The apparatus 400 includes a processor 410, a data storage 411, and optionally an I/O interface 430.

The processor 410 controls the operation of the apparatus 400. The processor 410 cooperates with the data storage 411.

The data storage 411 stores programs 420 executable by the processor 410. Data storage 411 may also optionally store program data such as flow tables, cloud component assignments, or the like as appropriate.

The processor-executable programs 420 may include an I/O interface program 421, a network controller program 423, a latency measurement program 425, a latency evaluation program 427, and a guest operating system 429. Processor 410 cooperates with processor-executable programs 420.

The I/O interface 430 cooperates with processor 410 and I/O interface program 421 to support communications over links 125, 135, and 155 of FIG. 1 as described above.

The network controller program 423 performs the steps 355 and 360 of method 300 of FIG. 3 as described above.

The latency measurement program 425 performs the steps 310, 315, and 320 of method 300 of FIG. 3 as described above.

The latency evaluation program of 427 performs steps 325, 330, 335, 340, 345, and 350 of method 300 of FIG. 3 as described above.

The guest operating system 429 may enable the apparatus 400 to manage various programs provided by a cloud consumer. In various embodiments, the processor-executable programs 420 may be software components of the guest operating system 429.

In some embodiments, the processor 410 may include resources such as processors/CPU cores, the I/O interface 430 may include any suitable network interfaces, or the data storage 411 may include memory or storage devices. Moreover the apparatus 400 may be any suitable physical hardware configuration such as: one or more server(s), blades consisting of components such as processor, memory, network interfaces or storage devices. In some of these embodiments, the apparatus 400 may include cloud network resources that are remote from each other.

In some embodiments, the apparatus 400 may be virtual machine. In some of these embodiments, the virtual machine may include components from different machines or be geographically dispersed. For example, the data storage 411 and the processor 410 may be in two different physical machines.

When processor-executable programs 420 are implemented on a processor 410, the program code segments combine with the processor to provide a unique device that operates analogously to specific logic circuits.

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

According to the foregoing, various exemplary embodiments provide for measurement of cloud network performance. In particular, by measuring mean latency and variance, a cloud consumer may obtain useful metrics of cloud network performance while minimizing network resources required for obtaining and storing the metrics.

It should be apparent from the foregoing description that various exemplary embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of evaluating service latency performance in a cloud-network, the method comprising:
determining, by a processor communicatively connected to a memory, a latency of a plurality of service requests in the cloud-network;
determining a mean latency of the plurality of service requests;
determining a variance of the plurality of service requests;
comparing the mean latency to a first threshold;
comparing the variance to a second threshold; and
determining that the cloud-network is deficient based on at least one of the mean latency exceeding the first threshold or the variance exceeding the second threshold.

2. The method of claim 1, wherein the performance threshold and the second threshold are defined by a service level agreement between a cloud consumer and a cloud provider.

3. The method of claim 1, wherein the step of measuring a latency comprises:
establishing a first counter accumulating a sum of individual latency measurements; and
establishing a second counter accumulating a sum of squared individual latency measurements.

4. The method of claim 1, further comprising estimating a tail latency based on the mean and variance.

5. The method of claim 4, wherein the step of estimating a tail latency comprises:
determining a sufficient condition having a maximum standard deviation allowed to meet a requirement based on the mean;
determining a standard deviation based on the mean and variance;
determining that the requirement has been met if the standard deviation is less than the maximum standard deviation.

6. The method of claim 1, further comprising sending a request to a cloud service provider for a service credit.

7. The method of claim 1, further comprising improving performance for an application hosted by the cloud-network based on the detected deficiency.

8. The method of claim 4, wherein improving performance comprises one of: allocating additional virtual resource capacity; migrating a virtual machine to a different host; and terminating a poorly performing virtual machine instance.

9. The method of claim 1, further comprising: storing the mean latency and variance for a measurement window.

10. The method of claim 1, wherein the latency is one of: transaction latency and subroutine latency.

11. The method of claim 1, wherein the latency is one of application service latency, scheduling latency, disk input/output latency, network latency, clock event jitter latency, and virtual machine allocation latency.

12. The method of claim 1, wherein the step of measuring is performed by an application hosted on a virtual machine of the cloud-network.

13. The method of claim 1, wherein the step of measuring is performed by a guest operating system being executed by a processor of the cloud-network.

14. A non-transitory machine-readable storage medium encoded with instructions executable by a processor, the non-transitory machine-readable storage medium comprising:
instructions for determining a latency of a plurality of service requests in a cloud-network;
instructions for determining a mean latency;
instructions for determining a variance of the plurality of service requests;
instructions for comparing the mean latency to a first threshold;
instructions for comparing the variance to a second threshold; and
instructions for determining that the cloud-network is deficient based on the mean latency exceeding the first threshold or variance exceeding the second threshold.

15. The non-transitory machine-readable storage medium of claim 14, further comprising instructions for sending a request to a cloud service provider for a service credit.

16. The non-transitory machine-readable storage medium of claim 14, further comprising improving performance of an application hosted by the cloud-network based on the detected deficiency.

17. The non-transitory machine-readable storage medium of claim 16 wherein improving performance comprises one of allocating additional virtual resource capacity, migrating a virtual machine to a different host, and terminating a poorly performing virtual machine instance.

18. The non-transitory machine-readable storage medium of claim 14, further comprising: instructions for storing the mean latency and variance for a measurement window.

19. The non-transitory machine-readable storage medium of claim 14, wherein the latency is one of: application service latency, scheduling latency, disk input/output latency, network latency, clock event jitter latency, and virtual machine allocation latency.

20. An apparatus for evaluating service latency performance in a cloud-network comprising:
a data storage; and
a processor communicatively connected to the data storage, the processor being configured to:
determine a latency of a plurality of service requests in a cloud-network;
determine a mean latency;
determine a variance of the plurality of service requests;
compare the mean latency to a first threshold;
compare the variance to a second threshold;
determine that the cloud-network is deficient based on the mean latency exceeding the first threshold or the variance exceeding the second threshold.
